(19) United States
(12) Patent Application Publication
(10) Pub. No.: US 2025/0168076 A1
(43) Pub. Date: May 22, 2025

(54) SYSTEM AND METHOD FOR GENERATING A VIRTUAL WIRELESS NODE

(71) Applicant: GM Global Technology Operations LLC, Detroit, MI (US)

(72) Inventor: Wenyuan Qi, Shanghai (CN)

(21) Appl. No.: 18/527,705

(22) Filed: Dec. 4, 2023

(30) Foreign Application Priority Data
Nov. 17, 2023 (CN) 2023115467010

(51) Int. Cl. H04L 41/122; H04L 41/14; H04W 24/02

(52) U.S. Cl. CPC H04L 41/122; H04L 41/145; H04W 24/02

(57) ABSTRACT

A system for generating a virtual wireless node includes a plurality of wireless nodes and one or more central computers in electrical communication with the plurality of wireless nodes. The one or more central computers are programmed to determine a plurality of optimal node parameters using a computer simulation and determine a plurality of differences and a plurality of constraints based at least in part on the plurality of optimal node parameters and a plurality of real node parameters. The one or more central computers are further programmed to determine a plurality of virtual node parameters for the virtual wireless node based at least in part on the plurality of differences and the plurality of constraints and adjust the plurality of real node parameters of the plurality of wireless nodes to generate the virtual wireless node based at least in part on the plurality of virtual node parameters.

### INTRODUCTION

The present disclosure relates wireless network infrastructure, and more particularly, to systems and methods for generating a virtual wireless node.

To increase occupant awareness and convenience, vehicles may be equipped with various sensors and systems such as, for example, perception sensors (e.g., camera, radar, ultrasonic distance sensors, and/or the like), microphones, navigation systems, advanced driver assistance systems (ADAS), automated driving systems (ADS), and/or the like. Such sensors and systems may produce data to be wirelessly transferred using cellular network infrastructure. Therefore, an increasing number of vehicles may utilize cellular network infrastructure to transfer critical data related to occupant awareness and convenience. However, changes in environmental conditions, including, for example, the construction of tall buildings and the introduction of a large number of connected vehicles may render the configuration of existing wireless network infrastructure in the environment nonideal. Constructing new and/or additional wireless network infrastructure may be challenging and/or resource intensive.

Thus, while current systems and methods for wireless network infrastructure achieve their intended purpose, there is a need for a new and improved system and method for generating a virtual wireless node to increase network performance under changing conditions.

### SUMMARY

According to several aspects, a system for generating a virtual wireless node is provided. The system may include a plurality of wireless nodes. The plurality of wireless nodes are defined by a plurality of real node parameters. The plurality of real node parameters includes a real node quantity, a plurality of real node locations, and a plurality of real node power levels. The system further may include one or more central computers in electrical communication with the plurality of wireless nodes. The one or more central computers are programmed to determine a plurality of optimal node parameters using a computer simulation. The one or more central computers are further programmed to determine a plurality of differences and a plurality of constraints based at least in part on the plurality of optimal node parameters and the plurality of real node parameters. The one or more central computers are further programmed to determine a plurality of virtual node parameters for the virtual wireless node based at least in part on the plurality of differences and the plurality of constraints. The one or more central computers are further programmed to adjust the plurality of real node parameters of the plurality of wireless nodes to generate the virtual wireless node based at least in part on the plurality of virtual node parameters.

In another aspect of the present disclosure, to determine the plurality of optimal node parameters using the computer simulation, the one or more central computers are further programmed to initialize a simulated environment. The simulated environment is defined by a plurality of simulated environment parameters. To determine the plurality of optimal node parameters using the computer simulation, the one or more central computers are further programmed to add a plurality of simulated wireless nodes to the simulated environment to form a simulated wireless network. The plurality of simulated wireless nodes are defined by a plurality of simulated node parameters. To determine the plurality of optimal node parameters using the computer simulation, the one or more central computers are further programmed to determine the plurality of optimal node parameters by iteratively optimizing the plurality of simulated node parameters until the simulated wireless network satisfies a performance metric target. The plurality of optimal node parameters includes an optimal node quantity, a plurality of optimal node locations, and a plurality of optimal node power levels.

In another aspect of the present disclosure, to determine the plurality of differences and the plurality of constraints, the one or more central computers are further programmed to determine the plurality of differences between the plurality of optimal node parameters and the plurality of real node parameters. The plurality of differences includes at least one of: a node quantity difference between the optimal node quantity and the real node quantity, a node location difference between the plurality of optimal node locations and the plurality of real node locations, and a node power level difference between the plurality of real node power levels and the plurality of optimal node power levels. To determine the plurality of differences and the plurality of constraints, the one or more central computers are further programmed to determine the plurality of constraints based at least in part on the plurality of real node parameters. The plurality of constraints includes at least one of: a node location constraint and a maximum node power level constraint.

In another aspect of the present disclosure, to determine the plurality of virtual node parameters, the one or more central computers are further programmed to determine a node location of the virtual wireless node based at least in part on the plurality of differences. To determine the plurality of virtual node parameters, the one or more central computers are further programmed to determine a node power level of the virtual wireless node based at least in part on the plurality of differences.

In another aspect of the present disclosure, to determine the node location of the virtual wireless node, the one or more central computers are further programmed to determine the node location of the virtual wireless node based at least in part on the node location difference. The node location of the virtual wireless node is one of the plurality of optimal node locations not contained within the plurality of real node locations.

In another aspect of the present disclosure, to adjust the plurality of real node parameters, the one or more central computers are further programmed to adjust at least one of: the plurality of real node power levels and a real node beamforming configuration of at least one of the plurality of wireless nodes to generate the virtual wireless node based on the plurality of virtual node parameters and the plurality of constraints.

In another aspect of the present disclosure, to adjust the plurality of real node parameters, the one or more central computers are further programmed to execute a node adjustment machine learning algorithm. The node adjustment machine learning algorithm is configured to receive the plurality of real node parameters and the plurality of virtual node parameters as an input and provide a plurality of adjusted real node parameters as an output. To adjust the plurality of real node parameters, the one or more central computers are further programmed to adjust the plurality of real node parameters based at least in part on the plurality of adjusted real node parameters.

In another aspect of the present disclosure, the node adjustment machine learning algorithm is further configured to balance resource allocation between each of the plurality of wireless nodes. The node adjustment machine learning algorithm is further configured to determine the plurality of adjusted real node parameters based at least in part on the plurality of constraints, such that the plurality of adjusted real node parameters do not violate any of the plurality of constraints.

In another aspect of the present disclosure, the one or more central computers are further programmed to train an activation state machine learning algorithm to activate the system. The activation state machine learning algorithm is configured to provide an activation state as an output. The activation state includes one of a positive activation state and a negative activation state. The one or more central computers are further programmed to execute the activation state machine learning algorithm to determine the activation state. The one or more central computers are further programmed to activate the system in response to identifying the positive activation state.

In another aspect of the present disclosure, the activation state machine learning algorithm is trained based on the plurality of real node parameters, the plurality of virtual node parameters, and the plurality of adjusted real node parameters. The activation state machine learning algorithm is configured to receive the plurality of real node parameters as an input and provide the activation state as the output.

According to several aspects, a method for generating a virtual wireless node is provided. The method may include determining a plurality of optimal node parameters using a computer simulation. The method further may include determining a plurality of differences and a plurality of constraints based at least in part on the plurality of optimal node parameters and a plurality of real node parameters of a plurality of wireless nodes. The plurality of real node parameters includes a real node quantity, a plurality of real node locations, and a plurality of real node power levels. The method further may include determining a plurality of virtual node parameters for the virtual wireless node based at least in part on the plurality of differences and the plurality of constraints. The method further may include adjusting the plurality of real node parameters of the plurality of wireless nodes to generate the virtual wireless node based at least in part on the plurality of virtual node parameters.

In another aspect of the present disclosure, determining the plurality of differences and the plurality of constraints further may include determining the plurality of differences between the plurality of optimal node parameters and the plurality of real node parameters. The plurality of differences includes at least one of: a node quantity difference between an optimal node quantity and the real node quantity, a node location difference between a plurality of optimal node locations and the plurality of real node locations, and a node power level difference between the plurality of real node power levels and a plurality of optimal node power levels. Determining the plurality of differences and the plurality of constraints further may include determining the plurality of constraints based at least in part on the plurality of real node parameters. The plurality of constraints includes at least one of: a node location constraint and a maximum node power level constraint.

In another aspect of the present disclosure, determining the plurality of virtual node parameters further may include determining a node location of the virtual wireless node based at least in part on the plurality of differences. Determining the plurality of virtual node parameters further may include determining a node power level of the virtual wireless node based at least in part on the plurality of differences.

In another aspect of the present disclosure, determining the node location of the virtual wireless node further may include determining the node location of the virtual wireless node based at least in part on the node location difference. The node location of the virtual wireless node is one of the plurality of optimal node locations not contained within the plurality of real node locations.

In another aspect of the present disclosure, adjusting the plurality of real node parameters further may include adjusting at least one of: one of the plurality of real node power levels and a real node beamforming configuration of at least one of the plurality of wireless nodes to generate the virtual wireless node based on the plurality of virtual node parameters and the plurality of constraints.

In another aspect of the present disclosure, adjusting the plurality of real node parameters further may include executing a node adjustment machine learning algorithm. The node adjustment machine learning algorithm is configured to receive the plurality of real node parameters and the plurality of virtual node parameters as an input and provide a plurality of adjusted real node parameters as an output. Adjusting the plurality of real node parameters further may include adjusting the plurality of real node parameters based at least in part on the plurality of adjusted real node parameters.

In another aspect of the present disclosure, the method further includes training an activation state machine learning algorithm based on the plurality of real node parameters, the plurality of virtual node parameters, and the plurality of adjusted real node parameters. The activation state machine learning algorithm is configured to receive the plurality of real node parameters as an input and provide an activation state as the output. The activation state machine learning algorithm is configured to provide an activation state as an output. The activation state includes one of a positive activation state and a negative activation state. The method further includes executing the activation state machine learning algorithm to determine the activation state. The method further includes performing the method in response to identifying the positive activation state.

According to several aspects, a system for generating a virtual wireless node is provided. The system may include a plurality of wireless nodes. The plurality of wireless nodes are defined by a plurality of real node parameters. The plurality of real node parameters includes a real node quantity, a plurality of real node locations, and a plurality of real node power levels. The system further may include one or more central computers in electrical communication with the plurality of wireless nodes. The one or more central computers are programmed to determine a plurality of optimal node parameters using a computer simulation. The one or more central computers are further programmed to determine a plurality of differences and a plurality of constraints based at least in part on the plurality of optimal node parameters and the plurality of real node parameters. The plurality of differences includes at least one of: a node quantity difference between an optimal node quantity and the real node quantity, a node location difference between a plurality of optimal node locations and the plurality of real node locations, and a node power level difference between the plurality of real node power levels and a plurality of optimal node power levels. The plurality of constraints includes at least one of: a node location constraint and a maximum node power level constraint. The one or more central computers are further programmed to determine a plurality of virtual node parameters for the virtual wireless node based at least in part on the plurality of differences and the plurality of constraints. The plurality of virtual node parameters includes at least a node location and a node power level. The one or more central computers are further programmed to adjust at least one of: one of the plurality of real node power levels and a real node beamforming configuration of at least one of the plurality of wireless nodes to generate the virtual wireless node based on the plurality of virtual node parameters and the plurality of constraints.

In another aspect of the present disclosure, to adjust the plurality of real node parameters, the one or more central computers are further programmed to execute a node adjustment machine learning algorithm. The node adjustment machine learning algorithm is configured to receive the plurality of real node parameters and the plurality of virtual node parameters as an input and provide a plurality of adjusted real node parameters as an output. The node adjustment machine learning algorithm is further configured to balance resource allocation between each of the plurality of wireless nodes. The node adjustment machine learning algorithm is further configured to determine the plurality of adjusted real node parameters based at least in part on the plurality of constraints, such that the plurality of adjusted real node parameters do not violate any of the plurality of constraints. To adjust the plurality of real node parameters, the one or more central computers are further programmed to adjust the plurality of real node parameters based at least in part on the plurality of adjusted real node parameters.

In another aspect of the present disclosure, the one or more central computers are further programmed to train an activation state machine learning algorithm to activate the system. The activation state machine learning algorithm is trained based on the plurality of real node parameters, the plurality of virtual node parameters, and the plurality of adjusted real node parameters. The activation state machine learning algorithm is configured to receive the plurality of real node parameters as an input and provide an activation state as an output. The activation state includes one of a positive activation state and a negative activation state. The one or more central computers are further programmed to execute the activation state machine learning algorithm to determine the activation state. The one or more central computers are further programmed to activate the system in response to identifying the positive activation state.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for generating a virtual wireless node, according to an exemplary embodiment;

FIG. 2 is a flowchart of a method for generating a virtual wireless node, according to an exemplary embodiment; and

FIG. 3 is a schematic diagram of a simulated wireless network for a computer simulation, according to an exemplary embodiment.

### DETAILED DESCRIPTION

The following description is merely exemplary in nature and is not intended to limit the present disclosure, application, or uses.

In aspects of the present disclosure, changes in environmental conditions, including, for example, the construction of tall buildings and the introduction of a large number of connected vehicles may render the configuration of existing wireless network infrastructure in the environment nonideal. Constructing new and/or additional wireless network infrastructure may be challenging and/or resource intensive. Accordingly, the present disclosure provides a new and improved system and method for generating a virtual wireless node by modifying software configuration of existing wireless network infrastructure. The virtual wireless node appears as an additional wireless node to end user equipment (e.g., connected vehicles), providing increased network performance.

The following description is merely exemplary in nature and is not intended to limit the present disclosure, application, or uses.

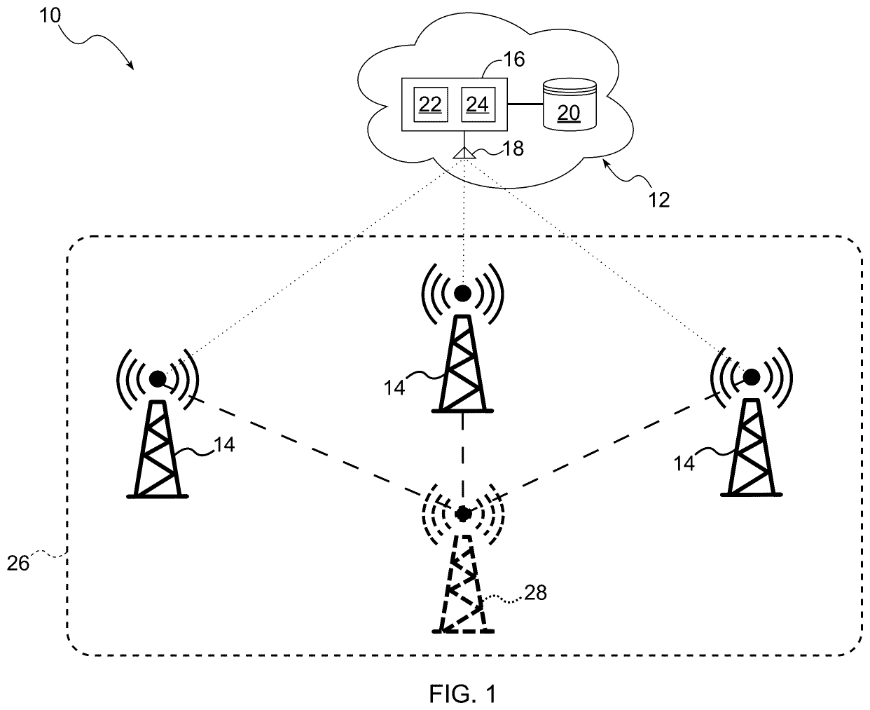

Referring to FIG. 1, a system for generating a virtual wireless node is illustrated and generally indicated by reference number 10. The system 10 generally includes one or more central computers 12 and a plurality of wireless nodes 14.

The one or more central computers 12 are used to implement a method 100 for generating a virtual wireless node, as will be described below. The one or more central computers 12 include at least one controller 16, a central computer communication system 18, and a database 20.

The controller 16 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the one or more central computers 12, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the one or more central computers 12 to perform the method 100.

The central computer communication system 18 is used by the controller 16 to communicate with other systems external to the one or more central computers 12. For example, the central computer communication system 18 includes capabilities for communication with vehicles (“V2I” communication). In certain embodiments, the central computer communication system 18 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the central computer communication system 18 may further include an embedded universal integrated circuit card (eUICC) configured to store at least one cellular connectivity configuration profile, for example, an embedded subscriber identity module (eSIM) profile. The central computer communication system 18 is further configured to communicate via a personal area network (e.g., BLUETOOTH), near-field communication (NFC), and/or any additional type of radiofrequency communication.

Accordingly, the central computer communication system 18 may include one or more antennas and/or communication transceivers for receiving and/or transmitting signals. The central computer communication system 18 is configured to wirelessly communicate information between the one or more central computers 12 and external communication networks, such as, for example, the internet. The central computer communication system 18 is in electrical communication with the controller 16. It should be understood that the central computer communication system 18 may be integrated with the one or more central computers 12 (e.g., on a same circuit board with the one or more central computers 12 or otherwise a part of the one or more central computers 12) without departing from the scope of the present disclosure.

The database 20 is used to store information about the virtual wireless node, as will be discussed in greater detail below. In an exemplary embodiment, the database 20 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the controller 16 may execute software such as, for example, a database management system (DBMS), allowing data stored on the one or more mass storage devices to be organized and accessed. The database 20 is in electrical communication with the controller 16.

The controller 16 is in electrical communication with the central computer communication system 18 and the database 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 16 are within the scope of the present disclosure.

The plurality of wireless nodes 14 are wireless telecommunications nodes. In the scope of the present disclosure, a wireless node is a site including electronic communications equipment (e.g., antennas, transceivers, digital signal processors, control electronics, and/or the like) configured to connect user equipment (UE) to a wireless network (e.g., a cellular network). In the scope of the present disclosure, UE includes, for example, mobile devices (e.g., cellular telephones, smartphones, laptops, and/or the like), internet of things (loT) devices, connected vehicles, and/or the like.

In an exemplary embodiment, each of the plurality of wireless nodes 14 includes one or more antennas and a base transceiver station (BTS). The one or more antennas are used to transmit and receive signals to and from the UE. The one or more antennas may include various types of antennas, for example, dipole antennas, such as dipole turnstile antennas, dipole corner reflector antennas, and dipole microstrip antennas. The one or more antennas may also include monopole antennas, such as monopole whip antennas. It should be understood that many additional types of antennas, such as array antennas, loop antennas, and aperture antennas may be used to transmit and receive radio signals to and from the UE without departing from the scope of the present disclosure.

The base transceiver station (BTS) is used to receive and transmit radiofrequency (RF) signals using the one or more antennas. In a non-limiting example, the BTS includes one or more RF transceivers, each of the one or more RF transceivers supporting a plurality of concurrent connections with UE. In another non-limiting example, the BTS may further include additional signal processing equipment such as, for example, equipment for encrypting and/or decrypting communications, spectral filters, multiplexers, amplifiers, and/or the like. In an exemplary embodiment, the BTS is in electrical communication with a core network infrastructure. In a non-limiting example, the connection to the core network infrastructure may be established using, for example, fiber optics, microwave links, satellite links, and/or the like. The connection between the each of the plurality of wireless nodes 14 and the core network infrastructure is sometimes referred to as a backhaul connection. In the scope of the present disclosure, the core network infrastructure is a central infrastructure which manages and routes network traffic from the UE across a wide area network (WAN), including, for example, a mobile switching center (MSC), an internet backbone, and/or the like.

In a non-limiting example, the plurality of wireless nodes 14 are gNodeB (next generation Node B) cellular network base stations configured to provide access to a 5G cellular network. It should be understood that the plurality of wireless nodes 14 may be other types of telecommunications nodes, including, for example, NodeB (i.e., 3G cellular network base stations), eNodeB (i.e., 4G cellular network base stations), WiFi access points, and/or the like.

The plurality of wireless nodes 14 are defined by a plurality of real node parameters. In an exemplary embodiment, the plurality of real node parameters includes, for example, a real node quantity of the plurality of wireless nodes 14 (e.g., three nodes, as shown in FIG. 1), a real node location for each of the plurality of wireless nodes 14 (i.e., a location of each of the plurality of wireless nodes 14 within the environment), a real node power level for each of the plurality of wireless nodes 14 (i.e., a radio transmission power of each of the plurality of wireless nodes 14 measured in, for example, watts), and a real node beamforming configuration for each of the plurality of wireless nodes 14 (i.e., operational settings employed for beamforming enabling each of the plurality of wireless nodes 14 to focus the transmission or reception of RF signals in a particular direction).

The plurality of wireless nodes 14 are operating within an environment 26. The environment 26 is characterized by a plurality of real environment parameters. In an exemplary embodiment, the plurality of real environment parameters includes, for example, an environment size (e.g., one hundred square kilometers), an environment traffic density (i.e., an amount of network traffic between UE and the plurality of wireless nodes 14), and a signal to interference and noise ratio (SINR) within the environment 26. In an exemplary embodiment, the plurality of real environment parameters are measured by one or more sensors in electrical communication with the one or more central computers 12 and/or stored in the database 20.

With continued reference to FIG. 1, the plurality of wireless nodes 14 are in electrical communication with the central computer communication system 18 of the one or more central computers 12. Accordingly, the one or more central computers 12 may use the central computer communication system 18 to adjust one or more of the plurality of real node parameters, such as, for example, the real node power level and/or the real node beamforming configuration of each of the plurality of wireless nodes 14.

Furthermore, the plurality of wireless nodes 14 are capable of generating a virtual wireless node 28. In the scope of the present disclosure, the virtual wireless node 28 is not a physical wireless node (like each of the plurality of wireless nodes 14), but rather a virtual or emulated wireless node. In other words, from the perspective of UE, the virtual wireless node 28 appears to be an additional one of the plurality of wireless nodes 14 in the environment 26. Changes in the plurality of environment parameters characterizing the environment 26, including, for example, changing SINR characteristics (e.g., resulting from the construction of tall buildings) and changing environment traffic density (e.g., resulting from the introduction of a large number of connected vehicles operating in the environment 26), and/or the like may render the existing real node location for each of the plurality of wireless nodes 14 nonideal. Therefore, generating the virtual wireless node 28 may be advantageous to increase network performance, signal strength, and/or the like. It should be understood that multiple virtual wireless nodes 28 may be generated using the plurality of wireless nodes 14 without departing from the scope of the present disclosure. To generate the virtual wireless node 28, the plurality of real node parameters of the plurality of wireless nodes 14 (e.g., the real node power level and/or the real node beamforming configuration of each of the plurality of wireless nodes 14) are adjusted, as will be discussed in greater detail below.

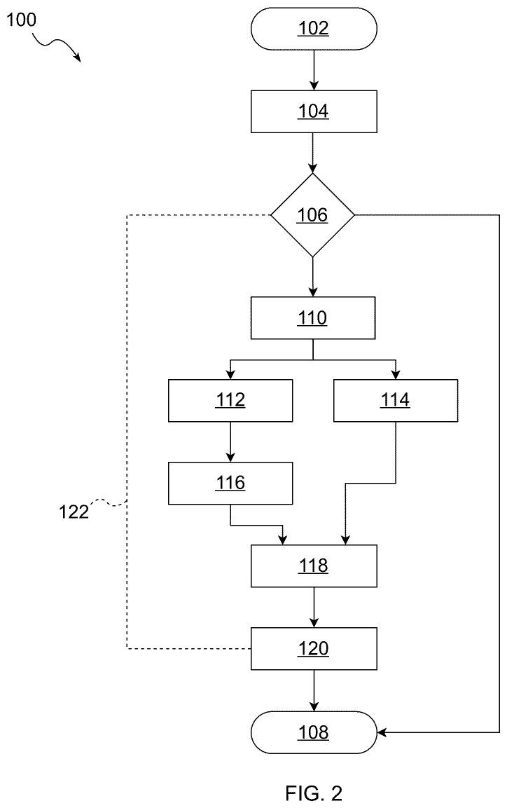

Referring to FIG. 2, a flowchart of the method 100 for generating a virtual wireless node is shown. The method 100 begins at block 102 and proceeds to block 104. At block 104, the one or more central computers 12 determine the plurality of real node parameters which define the plurality of wireless nodes 14. In an exemplary embodiment, the plurality of real node parameters are stored in the database 20 and retrieved by the controller 16. In another exemplary embodiment, the controller 16 uses the central computer communication system 18 to retrieve the plurality of real node parameters from one or more of the plurality of wireless nodes 14. After block 104, the method 100 proceeds to block 106.

At block 106, the one or more central computers 12 executes an activation state machine learning algorithm to determine an activation state. In an exemplary embodiment, the activation state machine learning algorithm is a machine learning algorithm configured to receive the plurality of real node parameters as an input and provide the activation state as an output. In the scope of the present disclosure, the activation state indicates whether the method 100 should proceed to generate the virtual wireless node 28. The activation state includes one of a positive activation state and a negative activation state. The activation state machine learning algorithm will be discussed in greater detail below. If the activation state is determined to be the negative activation state, the method 100 proceeds to enter a standby state at block 108. If the activation state is determined to be the positive activation state, the method 100 proceeds to block 110.

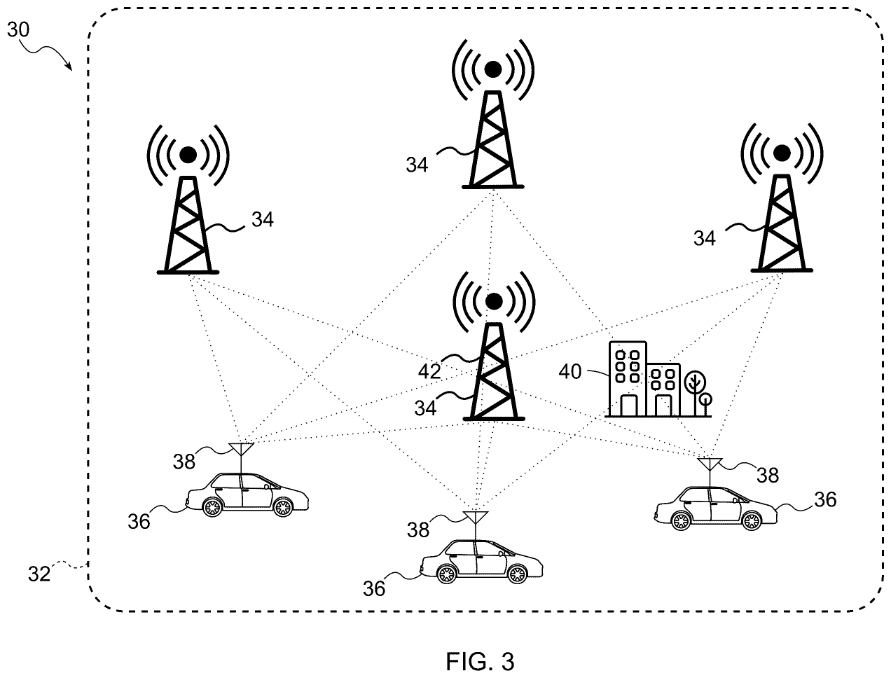

Referring to FIG. 3, a schematic diagram of a simulated wireless network 30 for a computer simulation is shown. The simulated wireless network 30 includes a simulated environment 32 and a plurality of simulated wireless nodes 34. The simulated environment 32 is defined by a plurality of simulated environment parameters. In an exemplary embodiment, the plurality of simulated environment parameters includes, for example, a simulated environment size (e.g., one hundred square kilometers), a simulated environment traffic density, and a simulated signal to interference and noise ratio (SINR). In the scope of the present disclosure, the simulated environment traffic density models a quantity of a plurality of simulated vehicles 36 in the simulated environment 32 and a wireless traffic volume of the plurality of simulated vehicles 36 in the simulated environment 32. Each of the plurality of simulated vehicles 36 has a vehicle wireless communication system 38 in wireless electrical communication with one or more of the plurality of simulated wireless nodes 34. The simulated SINR models noise and interference in the simulated environment 32 (e.g., noise and interference caused by simulated obstructions 40). It should be understood that the simulated SINR may be modeled as a constant value throughout the simulated environment 32 or a discrete or continuous varying value throughout the simulated environment 32.

The plurality of simulated wireless nodes 34 model wireless telecommunications nodes. In the scope of the present disclosure, a wireless node is a site including electronic communications equipment (e.g., antennas, transceivers, digital signal processors, control electronics, and/or the like) configured to connect user equipment (UE) to a wireless network (e.g., a cellular network), as discussed above.

The plurality of simulated wireless nodes 34 are defined by a plurality of simulated node parameters. In an exemplary embodiment, the plurality of simulated node parameters includes, for example, a quantity of the plurality of simulated wireless nodes 34 (e.g., four nodes, as shown in FIG. 3), a simulated node location for each of the plurality of simulated wireless nodes 34 (i.e., a location of each of the plurality of simulated wireless nodes 34 within the simulated environment 32), and a simulated node power level for each of the plurality of simulated wireless nodes 34 (i.e., a radio transmission power of each of the plurality of simulated wireless nodes measured in, for example, watts). The simulated environment 32 including the plurality of simulated wireless nodes 34 is referred to as the simulated wireless network 30.

Referring again to FIG. 2 and with continued reference to FIG. 3, at block 110, the one or more central computers 12 determine a plurality of optimal node parameters using the computer simulation. In the scope of the present disclosure, the plurality of optimal node parameters include an optimal node quantity, a plurality of optimal node locations, and a plurality of optimal node power levels. To determine the plurality of optimal node parameters, the one or more central computers 12 first initialize the simulated environment 32. As discussed above, the simulated environment 32 is defined by the plurality of simulated environment parameters. In an exemplary embodiment, the plurality of simulated environment parameters defining the simulated environment 32 are chosen to match the plurality of real environment parameters characterizing the environment 26.

After initializing the simulated environment 32, the one or more central computers 12 adds the plurality of simulated wireless nodes 34 to the simulated environment 32. In an exemplary embodiment, the plurality of simulated node parameters are chosen such that the plurality of simulated wireless nodes 34 includes at least one simulated wireless node 34 having a simulated node location matching the real node location of each of the plurality of wireless nodes 14.

After adding the plurality of simulated wireless nodes 34 to the simulated environment 32, the one or more central computers 12 determines the plurality of optimal node parameters by iteratively optimizing the plurality of simulated node parameters. In an exemplary embodiment, the plurality of simulated node parameters are iteratively optimized until the simulated wireless network 30 satisfies a performance metric target. In an exemplary embodiment, the one or more central computers 12 determines at least one performance metric of the simulated wireless network 30 (i.e., the simulated environment 32 with the plurality of simulated wireless nodes 34) for comparison with the performance metric target. In the scope of the present disclosure, the at least one performance metric includes at least one of: a simulated bandwidth usage, a simulated packet loss rate, a simulated packet retransmission rate, a simulated network throughput, a simulated network latency, a simulated network jitter, a simulated network uptime, and/or the like. In an exemplary embodiment, to determine the at least one performance metric, the one or more central computers 12 simulates network traffic between the plurality of simulated vehicles 36 and the plurality of simulated wireless nodes 34. During the network traffic simulation, the controller 16 determines the at least one performance metric of the simulated wireless network 30.

If the at least one performance metric does not satisfy the performance metric target, the plurality of simulated node parameters are adjusted. The simulation is repeated until the at least one performance metric satisfies the performance metric target. In some embodiments, aspects of the simulated environment parameters (e.g., the simulated SINR) are varied during simulation to test robustness to varying conditions. It should be understood that adjustment of the plurality of simulated node parameters may include adjustment of the simulated node power level of one or more of the plurality of simulated wireless nodes 34 and/or the addition of one or more additional simulated wireless nodes 42. In some embodiments, the simulated node location for each of the plurality of simulated wireless nodes 34 corresponding to each of the plurality of wireless nodes 14 is held constant during adjustment of the plurality of simulated node parameters. This is because the node location of each of the plurality of wireless nodes 14 in the environment 26 is fixed. After determination of the plurality of optimal node parameters at block 110, the method 100 proceeds to blocks 112 and 114.

At block 112, the one or more central computers 12 determine a plurality of differences between the plurality of optimal node parameters determined at block 110 and the plurality of real node parameters determined at block 104. In the scope of the present disclosure, the plurality of differences includes at least one of: a node quantity difference between the optimal node quantity and the real node quantity, a node location difference between the plurality of optimal node locations and the plurality of real node locations, and a node power level difference between the plurality of real node power levels and the plurality of optimal node power levels. After block 112, the method 100 proceeds to block 116.

At block 116, the one or more central computers 12 determines a plurality of virtual node parameters. The plurality of virtual node parameters includes at least: a node location of the virtual wireless node 28 and a node power level of the virtual wireless node 28. The plurality of virtual node parameters are determined based at least in part on the plurality of differences determined at block 112. In an exemplary embodiment, the one or more central computers 12 determines the node location of the virtual wireless node 28 based at least in part on the node location difference determined at block 112. In a non-limiting example, the node location of the virtual wireless node 28 is the same as the simulated node location of the additional simulated wireless node 42. In other words, the node location of the virtual wireless node 28 is one of the plurality of optimal node locations not contained within the plurality of real node locations. The node power level of the virtual wireless node 28 is the same as the simulated node power level of the additional simulated wireless node 42. After block 116, the method 100 proceeds to block 118, as will be discussed in greater detail below.

At block 114, the one or more central computers 12 determines a plurality of constraints. In the scope of the present disclosure, the plurality of constraints quantify operational constraints of the plurality of wireless nodes 14. In a non-limiting example, the plurality of constraints includes at least one of: a node location constraint and a maximum node power level constraint. The node location constraint indicates an ability of each of the plurality of wireless nodes 14 to change location. In some embodiments, at least one of the plurality of wireless nodes 14 has a fixed location. In some embodiments, at least one of the plurality of wireless nodes 14 is mobile and is capable of changing location. The maximum node power level constraint quantifies a maximum transmission power level of each of the plurality of wireless nodes 14, as determined by hardware capabilities and/or regulatory compliance. In an exemplary embodiment, the plurality of constraints are stored in the database 20 and retrieved by the controller 16. In another exemplary embodiment, the controller 16 uses the central computer communication system 18 to retrieve the plurality of constraints from one or more of the plurality of wireless nodes 14. After block 114, the method 100 proceeds to block 118.

At block 118, the one or more central computers 12 adjusts the plurality of real node parameters to generate the virtual wireless node 28 based at least in part on the plurality of virtual node parameters determined at block 116 and the plurality of constraints determined at block 114. In an exemplary embodiment, the one or more central computers 12 adjust at least one of: the plurality of real node power levels and the real node beamforming configuration of at least one of the plurality of wireless nodes 14 to generate the virtual wireless node 28.

In an exemplary embodiment, the one or more central computers 12 execute a node adjustment machine learning algorithm. The node adjustment machine learning algorithm is configured to receive the plurality of real node parameters as an input and provide a plurality of adjusted real node parameters as an output.

In a non-limiting example, the node adjustment machine learning algorithm includes multiple layers, including an input layer and an output layer, as well as one or more hidden layers. The input layer receives the plurality of real node parameters and the plurality of virtual node parameters as inputs. The inputs are then passed on to the hidden layers. Each hidden layer applies a transformation (e.g., a non-linear transformation) to the data and passes the result to the next hidden layer until the final hidden layer. The output layer produces the plurality of adjusted real node parameters.

To train the node adjustment machine learning algorithm, a dataset of inputs and their corresponding adjusted real node parameters is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to process new input data.

After sufficient training of the node adjustment machine learning algorithm, the algorithm is capable of accurately and precisely determining the plurality of adjusted real node parameters based on the plurality of real node parameters and the plurality of virtual node parameters. By adjusting the weights between the nodes in each hidden layer during training, the algorithm “learns” to recognize patterns in the input data that are indicative of the plurality of adjusted real node parameters.

In an exemplary embodiment, the node adjustment machine learning algorithm is further configured to balance resource allocation between each of the plurality of wireless nodes. The node adjustment machine learning algorithm is further configured to determine the plurality of adjusted real node parameters based at least in part on the plurality of constraints, such that the plurality of adjusted real node parameters do not violate any of the plurality of constraints. For example, the node adjustment machine learning algorithm is configured to ensure that the plurality of adjusted real node parameters do not violate the maximum node power level constraint for any of the plurality of wireless nodes 14.

It should be understood that the one or more central computers 12 adjusts the plurality of real node parameters to generate the virtual wireless node 28 based on the plurality of adjusted real node parameters. The virtual wireless node 28 is not a physical wireless node (like each of the plurality of wireless nodes 14), but rather a virtual or emulated wireless node. In other words, from the perspective of UE, the virtual wireless node 28 appears to be an additional one of the plurality of wireless nodes 14 in the environment 26. It should be understood that any method for generating the virtual wireless node 28, including, for example, signal processing techniques such as beamforming and/or the like are within the scope of the present disclosure. After block 118, the method 100 proceeds to block 120.

At block 120, the one or more central computers 12 train the activation state machine learning algorithm used to activate the system at block 106. The activation state machine learning algorithm is used to identify situations where generation of the virtual wireless node 28 is advantageous for network performance. As discussed above, the activation state machine learning algorithm is configured to receive the plurality of real node parameters as an input and provide the activation state as an output.

In a non-limiting example, the activation state machine learning algorithm includes multiple layers, including an input layer and an output layer, as well as one or more hidden layers. The input layer receives the plurality of real node parameters as an input. The input is then passed on to the hidden layers. Each hidden layer applies a transformation (e.g., a non-linear transformation) to the data and passes the result to the next hidden layer until the final hidden layer. The output layer produces the activation state.

To train the activation state machine learning algorithm, a dataset including pluralities of real node parameters, pluralities of virtual node parameters, and pluralities of adjusted real node parameters and their corresponding activation state is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to classify new input data.

After sufficient training of the activation state machine learning algorithm, the algorithm is capable of accurately and precisely determining activation state based on the plurality of real node parameters. By adjusting the weights between the nodes in each hidden layer during training, the algorithm “learns” to recognize patterns in the data that are indicative of activation state.

As indicated by the dashed line 122 in FIG. 2, the activation state machine learning algorithm trained at block 120 is used to determine the activation state at block 106, as discussed above. After block 120, the method 100 proceeds to enter the standby state at block 108.

In an exemplary embodiment, the one or more central computers 12 repeatedly exits the standby state 108 and restarts the method 100 at block 102. In a non-limiting example, the one or more central computers 12 exits the standby state 108 and restarts the method 100 on a timer, for example, every three hundred milliseconds.

The system 10 and method 100 of the present disclosure offer several advantages. Changes in environmental conditions, including, for example, the construction of tall buildings and the introduction of a large number of connected vehicles may render the configuration of existing wireless network infrastructure in the environment nonideal. Constructing new and/or additional wireless network infrastructure may be challenging and/or resource intensive. The system 10 and method 100 allow for generation of a virtual 28 wireless node without hardware modification to the existing plurality of wireless nodes 14. The system 10 and method 100 are configured to adaptively identify opportunities for virtual node generation using the activation state machine learning algorithm, allowing for deployment of the system 10 and method 100 across diverse network conditions. The system 10 and method 100 are further configured to determine the location for the virtual wireless node using computer simulation in order to arrive at an optimal location for improvement of the network performance within the constraints of the capabilities of the existing plurality of wireless nodes 14.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for generating a virtual wireless node, the system comprising:
a plurality of wireless nodes, wherein the plurality of wireless nodes are defined by a plurality of real node parameters, wherein the plurality of real node parameters includes a real node quantity, a plurality of real node locations, and a plurality of real node power levels; and
one or more central computers in electrical communication with the plurality of wireless nodes, wherein the one or more central computers are programmed to:
determine a plurality of optimal node parameters using a computer simulation;
determine a plurality of differences and a plurality of constraints based at least in part on the plurality of optimal node parameters and the plurality of real node parameters;
determine a plurality of virtual node parameters for the virtual wireless node based at least in part on the plurality of differences and the plurality of constraints; and
adjust the plurality of real node parameters of the plurality of wireless nodes to generate the virtual wireless node based at least in part on the plurality of virtual node parameters.

2. The system of claim 1, wherein to determine the plurality of optimal node parameters using the computer simulation, the one or more central computers are further programmed to:
initialize a simulated environment, wherein the simulated environment is defined by a plurality of simulated environment parameters;
add a plurality of simulated wireless nodes to the simulated environment to form a simulated wireless network, wherein the plurality of simulated wireless nodes are defined by a plurality of simulated node parameters; and
determine the plurality of optimal node parameters by iteratively optimizing the plurality of simulated node parameters until the simulated wireless network satisfies a performance metric target, wherein the plurality of optimal node parameters includes an optimal node quantity, a plurality of optimal node locations, and a plurality of optimal node power levels.

3. The system of claim 2, wherein to determine the plurality of differences and the plurality of constraints, the one or more central computers are further programmed to:
determine the plurality of differences between the plurality of optimal node parameters and the plurality of real node parameters, wherein the plurality of differences includes at least one of: a node quantity difference between the optimal node quantity and the real node quantity, a node location difference between the plurality of optimal node locations and the plurality of real node locations, and a node power level difference between the plurality of real node power levels and the plurality of optimal node power levels; and
determine the plurality of constraints based at least in part on the plurality of real node parameters, wherein the plurality of constraints includes at least one of: a node location constraint and a maximum node power level constraint.

4. The system of claim 3, wherein to determine the plurality of virtual node parameters, the one or more central computers are further programmed to:
determine a node location of the virtual wireless node based at least in part on the plurality of differences; and
determine a node power level of the virtual wireless node based at least in part on the plurality of differences.

5. The system of claim 4, wherein to determine the node location of the virtual wireless node, the one or more central computers are further programmed to:
determine the node location of the virtual wireless node based at least in part on the node location difference, wherein the node location of the virtual wireless node is one of the plurality of optimal node locations not contained within the plurality of real node locations.

6. The system of claim 4, wherein to adjust the plurality of real node parameters, the one or more central computers are further programmed to:
adjust at least one of: the plurality of real node power levels and a real node beamforming configuration of at least one of the plurality of wireless nodes to generate the virtual wireless node based on the plurality of virtual node parameters and the plurality of constraints.

7. The system of claim 6, wherein to adjust the plurality of real node parameters, the one or more central computers are further programmed to:
execute a node adjustment machine learning algorithm, wherein the node adjustment machine learning algorithm is configured to receive the plurality of real node parameters and the plurality of virtual node parameters as an input and provide a plurality of adjusted real node parameters as an output; and
adjust the plurality of real node parameters based at least in part on the plurality of adjusted real node parameters.

8. The system of claim 7, wherein the node adjustment machine learning algorithm is further configured to balance resource allocation between each of the plurality of wireless nodes, and wherein the node adjustment machine learning algorithm is further configured to determine the plurality of adjusted real node parameters based at least in part on the plurality of constraints, such that the plurality of adjusted real node parameters do not violate any of the plurality of constraints.

9. The system of claim 7, wherein the one or more central computers are further programmed to:
train an activation state machine learning algorithm to activate the system, wherein the activation state machine learning algorithm is configured to provide an activation state as an output, wherein the activation state includes one of a positive activation state and a negative activation state;
execute the activation state machine learning algorithm to determine the activation state; and
activate the system in response to identifying the positive activation state.

10. The system of claim 9, wherein the activation state machine learning algorithm is trained based on the plurality of real node parameters, the plurality of virtual node parameters, and the plurality of adjusted real node parameters, and wherein the activation state machine learning algorithm is configured to receive the plurality of real node parameters as an input and provide the activation state as the output.

11. A method for generating a virtual wireless node, the method comprising:
determining a plurality of optimal node parameters using a computer simulation;
determining a plurality of differences and a plurality of constraints based at least in part on the plurality of optimal node parameters and a plurality of real node parameters of a plurality of wireless nodes, wherein the plurality of real node parameters includes a real node quantity, a plurality of real node locations, and a plurality of real node power levels;
determining a plurality of virtual node parameters for the virtual wireless node based at least in part on the plurality of differences and the plurality of constraints; and
adjusting the plurality of real node parameters of the plurality of wireless nodes to generate the virtual wireless node based at least in part on the plurality of virtual node parameters.

12. The method of claim 11, wherein determining the plurality of differences and the plurality of constraints further comprises:
determining the plurality of differences between the plurality of optimal node parameters and the plurality of real node parameters, wherein the plurality of differences includes at least one of: a node quantity difference between an optimal node quantity and the real node quantity, a node location difference between a plurality of optimal node locations and the plurality of real node locations, and a node power level difference between the plurality of real node power levels and a plurality of optimal node power levels; and
determining the plurality of constraints based at least in part on the plurality of real node parameters, wherein the plurality of constraints includes at least one of: a node location constraint and a maximum node power level constraint.

13. The method of claim 12, wherein determining the plurality of virtual node parameters further comprises:
determining a node location of the virtual wireless node based at least in part on the plurality of differences; and
determining a node power level of the virtual wireless node based at least in part on the plurality of differences.

14. The method of claim 13, wherein determining the node location of the virtual wireless node further comprises:
determining the node location of the virtual wireless node based at least in part on the node location difference, wherein the node location of the virtual wireless node is one of the plurality of optimal node locations not contained within the plurality of real node locations.

15. The method of claim 14, wherein adjusting the plurality of real node parameters further comprises:
adjusting at least one of: one of the plurality of real node power levels and a real node beamforming configuration of at least one of the plurality of wireless nodes to generate the virtual wireless node based on the plurality of virtual node parameters and the plurality of constraints.

16. The method of claim 15, wherein adjusting the plurality of real node parameters further comprises:
executing a node adjustment machine learning algorithm, wherein the node adjustment machine learning algorithm is configured to receive the plurality of real node parameters and the plurality of virtual node parameters as an input and provide a plurality of adjusted real node parameters as an output; and
adjusting the plurality of real node parameters based at least in part on the plurality of adjusted real node parameters.

17. The method of claim 16, further comprising:
training an activation state machine learning algorithm based on the plurality of real node parameters, the plurality of virtual node parameters, and the plurality of adjusted real node parameters, wherein the activation state machine learning algorithm is configured to receive the plurality of real node parameters as an input and provide an activation state as the output, and wherein the activation state machine learning algorithm is configured to provide an activation state as an output, wherein the activation state includes one of a positive activation state and a negative activation state;
executing the activation state machine learning algorithm to determine the activation state; and
performing the method in response to identifying the positive activation state.

18. A system for generating a virtual wireless node, the system comprising:
a plurality of wireless nodes, wherein the plurality of wireless nodes are defined by a plurality of real node parameters, wherein the plurality of real node parameters includes a real node quantity, a plurality of real node locations, and a plurality of real node power levels; and
one or more central computers in electrical communication with the plurality of wireless nodes, wherein the one or more central computers are programmed to:
determine a plurality of optimal node parameters using a computer simulation;
determine a plurality of differences and a plurality of constraints based at least in part on the plurality of optimal node parameters and the plurality of real node parameters, wherein the plurality of differences includes at least one of: a node quantity difference between an optimal node quantity and the real node quantity, a node location difference between a plurality of optimal node locations and the plurality of real node locations, and a node power level difference between the plurality of real node power levels and a plurality of optimal node power levels, and wherein the plurality of constraints includes at least one of: a node location constraint and a maximum node power level constraint;
determine a plurality of virtual node parameters for the virtual wireless node based at least in part on the plurality of differences and the plurality of constraints, wherein the plurality of virtual node parameters includes at least a node location and a node power level; and
adjust at least one of: one of the plurality of real node power levels and a real node beamforming configuration of at least one of the plurality of wireless nodes to generate the virtual wireless node based on the plurality of virtual node parameters and the plurality of constraints.

19. The system of claim 18, wherein to adjust the plurality of real node parameters, the one or more central computers are further programmed to:
execute a node adjustment machine learning algorithm, wherein the node adjustment machine learning algorithm is configured to receive the plurality of real node parameters and the plurality of virtual node parameters as an input and provide a plurality of adjusted real node parameters as an output, and wherein the node adjustment machine learning algorithm is further configured to balance resource allocation between each of the plurality of wireless nodes, wherein the node adjustment machine learning algorithm is further configured to determine the plurality of adjusted real node parameters based at least in part on the plurality of constraints, such that the plurality of adjusted real node parameters do not violate any of the plurality of constraints; and
adjust the plurality of real node parameters based at least in part on the plurality of adjusted real node parameters.

20. The system of claim 19, wherein the one or more central computers are further programmed to:
train an activation state machine learning algorithm to activate the system, wherein the activation state machine learning algorithm is trained based on the plurality of real node parameters, the plurality of virtual node parameters, and the plurality of adjusted real node parameters, wherein the activation state machine learning algorithm is configured to receive the plurality of real node parameters as an input and provide an activation state as an output, and wherein the activation state includes one of a positive activation state and a negative activation state;
execute the activation state machine learning algorithm to determine the activation state; and
activate the system in response to identifying the positive activation state.
